(19) United States
(12) Patent Application Publication
(10) Pub. No.: US 2007/0101543 A1
(43) Pub. Date: May 10, 2007

(54) Hinge

(75) Inventors: Sheng-Nan Lu, Shulin City (TW); Hsiang-Chi Chien, Shulin City (TW)

Correspondence Address: BACON & THOMAS, PLLC, 625 SLATERS LANE, FOURTH FLOOR, ALEXANDRIA, VA, 22314, US

(73) Assignee: Shin Zu Shing Co., Ltd., Taipei Hsien (TW)

(21) Appl. No.: 11/266,196

(22) Filed: Nov. 4, 2005

(51) Int. Cl. E05D 11/08

(52) U.S. Cl. 16/342

(57) ABSTRACT

A hinge is mounted in an appliance with a cover and a base and has a stationary bracket, multiple resilient spacers and a pintle. The stationary bracket is attached to the base of the appliance and has a tubular sleeve. The resilient spacers are mounted securely in the sleeve. The pintle is attached to the cover of the appliance and is mounted rotatably in the resilient spacers. With multiple resilient spacers, the area to provide friction between the resilient spacers and the pintle is increased. Therefore, the friction between the resilient spacers and the pintle is increased and is sufficient to easily hold the cover at any desired angle.

### BACKGROUND OF THE INVENTION

1. Field of the Invention

The present invention relates to a hinge, especially to a hinge with increased friction to be mounted in a notebook computer.

2. Description of the Prior Arts

Many appliances and electronic devices have a base and a cover, for example notebook computers. A hinge is usually mounted between the base and the cover and pivots to open or close the cover. Some hinges are required to pivot open and be able to remain open at various angles. A conventional hinge of this type comprises a shaft and two resilient sleeves. The shaft is mounted rotatably in the resilient sleeves and is attached to the cover. The resilient sleeves are attached to the base. When the hinge is pivoted to open the cover, the shaft is rotated in the resilient sleeves. The contact between the outer wall of the shaft and the inner walls of the resilient sleeves provides friction that is sufficient to hold the cover at any angle desired. However, if there is any imprecision in the inner walls of the resilient sleeves, the outer wall of the shaft may not be able to completely contact the inner walls of the resilient sleeves. Insufficient contact would provide less friction such that the hinge may not be able to hold the cover open at a desired angle.

To overcome the shortcomings, the present invention provides a hinge to reinforce friction to mitigate or obviate the aforementioned problems.

### SUMMARY OF THE INVENTION

The main objective of the present invention is to provide a hinge with reinforced friction. The hinge of the present invention is mounted on an appliance with a cover and a base and has a stationary bracket, multiple resilient spacers and a pintle. The stationary bracket is attached to the base of the appliance and has a tubular sleeve. The resilient spacers are mounted securely in the sleeve. The pintle is attached to the cover of the appliance and is mounted rotatably in the resilient spacers. With multiple resilient spacers, the area to provide friction between the resilient spacers and the pintle are increased. Therefore, the friction between the resilient spacers and the pintle is increased to easily hold the cover at any desired angle.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge in accordance with the present invention;

FIG. 2 is a front view of a first embodiment of a resilient spacer of the hinge in FIG. 1;

FIG. 3 is a front view of a second embodiment of a resilient spacer of the hinge in accordance with the present invention;

FIG. 4 is a front view of a third embodiment of a resilient spacer of the hinge in accordance with the present invention;

FIG. 5 is an exploded perspective view of another embodiment of the hinge in accordance with the present invention;

FIG. 6 is an operational end view of the hinge in FIG. 1; and

FIG. 7 is an operational end view of the hinge in FIG. 1.

### DETAILED DESCRIPTION OF THE PREFERRED EMBODIMENTS

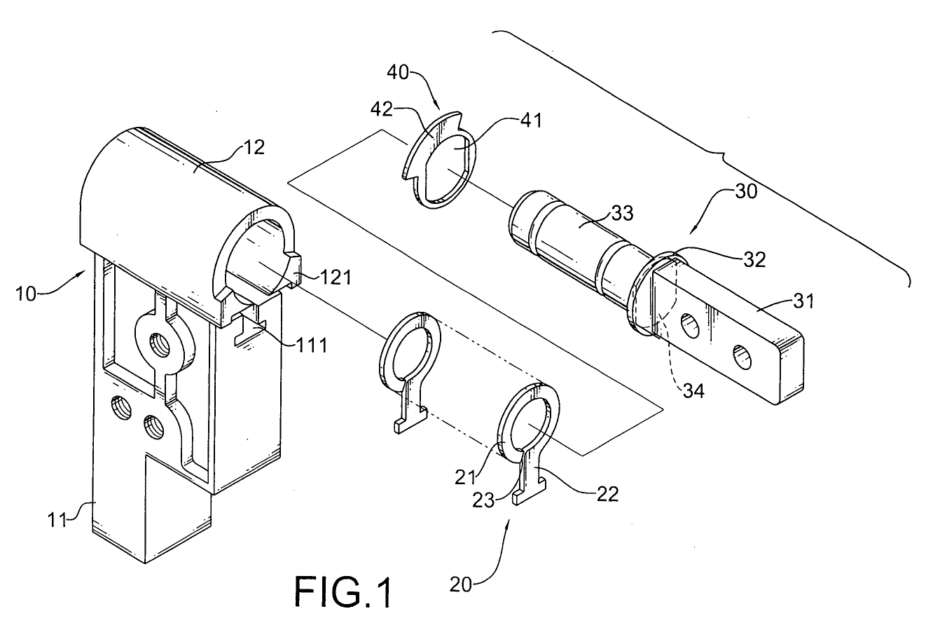

With reference to FIG. 1, a hinge in accordance with the present invention, which is mounted in an appliance with a cover and a base, comprises a stationary bracket (10), multiple resilient spacers (20), a pintle (30) and an optional limiting spacer (40).

The stationary bracket (10) has a fastening segment (11) and a sleeve (12). The fastening segment (11) is attached to the base of the appliance and has a side and an elongated keyway (111). The elongated keyway (111) is formed longitudinally in the side of the fastening segment (11) and has an open end and a cross-sectional shape. The sleeve (12) is tubular, is formed on the side of the fastening segment (11), communicates with the elongated keyway (111) and has an opening and two optional limiting stops (121). The open end of the sleeve (12) corresponds to the open end of the elongated keyway (111). The limiting stops (121) are formed on and extend out of opposite sides of the open end of the sleeve (12).

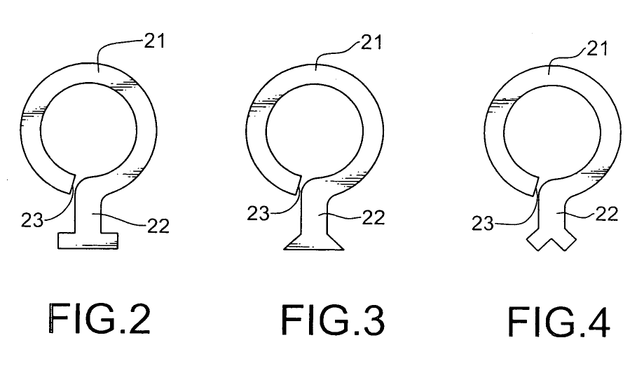

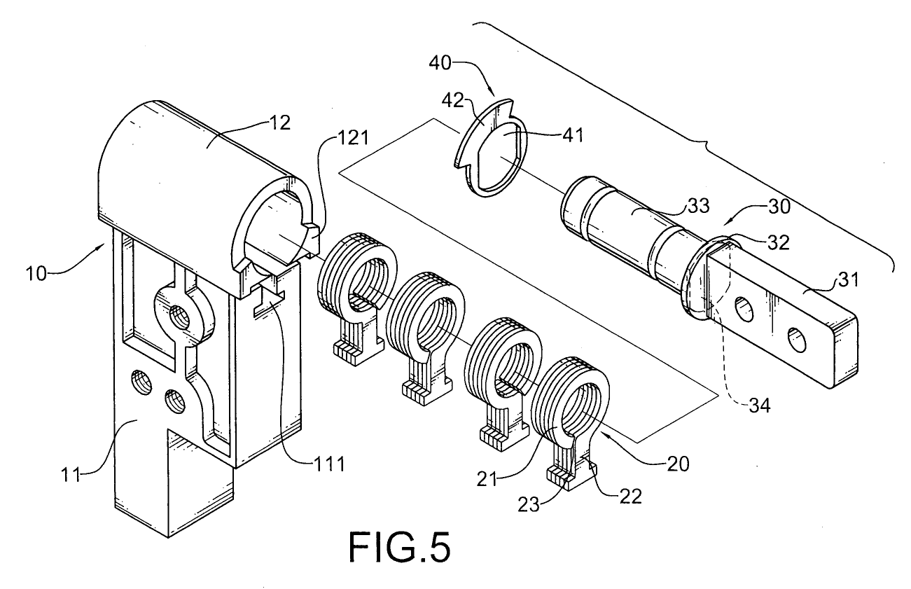

The resilient spacers (20) are mounted securely in the sleeve (12). Each resilient spacer (20) has a ring (21), a gap (23) and a key protrusion (22). The ring (21) is mounted in and corresponds to the sleeve (12) and has a distal end, a proximal end, an inner wall and an inner diameter. The distal and proximal ends of the ring (21) are separated. The gap (23) is formed between the distal and proximal ends of the ring (21). With reference to FIGS. 1 and 5, the gaps (23) of adjacent resilient spacers (20) may or may not align with one another. The key protrusion (22) is formed on and extends out from the proximal end of the ring (21), is mounted in and engages the elongated keyway (111) and has a shape. With further reference to FIGS. 2-4, the shape of the key protrusion (22) corresponds to the cross-sectional shape of the elongated keyway (111) and may be T-shaped, triangular or Y-shaped.

The pintle (30) is mounted rotatably in the rings (21) and may have an outside rod (31), a head (32), an inside rod (33) and an optional positioning protrusion (34). The outside rod (31) is attached to the cover of the appliance and has a distal end and a proximal end. The head (32) is formed on the proximal end of the outside rod (31) and has an outside surface and an inside surface. The outside surface of the head (32) is adjacent to the proximal end of the outside rod (31). The inside rod (33) is formed axially on and extends out from the inside surface of the head (32), extends rotatably into the rings (21) of the resilient spacers (20), selectively contacts the inner walls of rings (21) and has an outer diameter. The outer diameter of the inside rod (33) is larger than the inner diameters of the rings (21). The positioning protrusion (34) is non-circular, corresponds to the limiting stops (121) on the sleeve (12) and is formed between the inside surface of the head (32) and the inside rod (33).

The limiting spacer (40) is mounted securely on the pintle (30) and has a keyhole (41), an edge and a limiting protrusion (42). The keyhole (41) engages the positioning protrusion (34) of the pintle (30) to mount the limiting spacer (40) securely on the pintle (30). The limiting protrusion (42) is formed transversely on the edge of the limiting spacer (40) and selectively abuts the limiting stops (121) on the sleeve (12) to limit the rotation of the pintle (30).

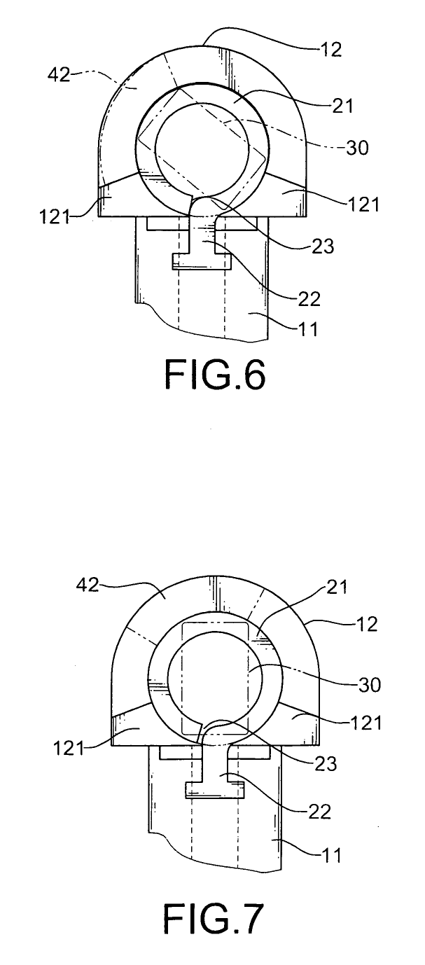

With reference to FIGS. 1, 5, 6 and 7, when the gaps (23) of the rings (21) do not align to one another, the force exerted on the pintle (30) by the resilient spacers (20) is the same in each direction of rotation. When the gaps (23) of the rings (21) are aligned with one another, the force exerted on the pintle (30) by the resilient spacers (20) is different in each direction of rotation. When the pintle (30) is rotated to close the cover of the appliance, the friction between the inside rod (33) and the rings (21) lengthens the rings (21) to force the gaps (23) to close. The rings (21) will exert a resisting force on the pintle (30) to prevent the gaps (23) from closing. This resistance keeps the cover from bumping into the base too hard when the cover is closed. On the contrary, when the pintle (30) is rotated to open the cover of the appliance, the friction between the inside rod (33) and the rings (21) allows the rings (21) the gaps (23) to recover. The rings (21) will release stored resilient energy to the pintle (30) to help recover the gaps (23). The stored resilient energy helps to open the cover easily.

With multiple resilient spacers (20), each resilient spacer (20) can contact the pintle (30) to increase the area providing friction. Therefore, the friction is increased and is sufficient to easily hold the cover at any desired angle.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a stationary bracket having
a fastening segment having
a side; and
an elongated keyway formed longitudinally in the side of the fastening segment and having an open end and a cross-sectional shape; and
a sleeve being tubular, formed on the side of the fastening segment, communicating with the elongated keyway and having
an open end corresponding to the open end of the elongated keyway;
multiple resilient spacers mounted securely in the sleeve, and each resilient spacer having
a ring mounted in and corresponds to the sleeve and having
a distal end;
a proximal end separated from the distal end;
an inner wall; and
an inner diameter;
a gap formed between the distal and proximal ends of the ring; and
a key protrusion formed on and extending out from the proximal end of the ring, mounted in and engaging the elongated keyway and having a shape corresponding to the cross-sectional shape of the elongated keyway; and
a pintle mounted rotatably in the rings.

2. The hinge as claimed in claim 1, wherein the gaps of the resilient spacers align with one another.

3. The hinge as claimed in claim 1, wherein the gaps of the resilient spacers misalign with one another.

4. The hinge as claimed in claim 1, wherein the pintle has
an outside rod having a distal end and a proximal end;
a head formed on the proximal end of the outside rod and having
an outside surface adjacent to the proximal end of the outside rod; and
an inside surface; and
an inside rod formed axially on and extending out from the inside surface of the head, extending rotatably into the rings of the resilient spacers and having an outer diameter larger than the inner diameter of the rings.

5. The hinge as claimed in claim 2, wherein the pintle has
an outside rod having a distal end and a proximal end;
a head formed on the proximal end of the outside rod and having
an outside surface adjacent to the proximal end of the outside rod; and
an inside surface; and
an inside rod formed axially on and extending out from the inside surface of the head, extending rotatably into the rings of the resilient spacers and having an outer diameter larger than the inner diameter of the rings.

6. The hinge as claimed in claim 3, wherein the pintle has
an outside rod having a distal end and a proximal end;
a head formed on the proximal end of the outside rod and having
an outside surface adjacent to the proximal end of the outside rod; and
an inside surface; and
an inside rod formed axially on and extending out from the inside surface of the head, extending rotatably into the rings of the resilient spacers and having an outer diameter larger than the inner diameter of the rings.

7. The hinge as claimed in claim 4, wherein
the sleeve of the stationary bracket has two limiting stops formed on and extending out from opposite sides of the open end of the sleeve;
the pintle has a non-circular positioning protrusion corresponding to the limiting stops on the sleeve and formed between the inside surface of the head and the inside rod; and
a limiting spacer is mounted securely on the pintle and has
a keyhole engaging the positioning protrusion of the pintle;
an edge; and
a limiting protrusion formed transversely on the edge of the limiting spacer and selectively abutting the limiting stops on the sleeve.

8. The hinge as claimed in claim 5, wherein
the sleeve of the stationary bracket has two limiting stops formed on and extending out from opposite sides of the open end of the sleeve;
the pintle has a non-circular positioning protrusion corresponding to the limiting stops on the sleeve and formed between the inside surface of the head and the inside rod; and
a limiting spacer is mounted securely on the pintle and has
a keyhole engaging the positioning protrusion of the pintle;
an edge; and
a limiting protrusion formed transversely on the edge of the limiting spacer and selectively abutting the limiting stops on the sleeve.

9. The hinge as claimed in claim 6, wherein
the sleeve of the stationary bracket has two limiting stops formed on and extending out from opposite sides of the open end of the sleeve;
the pintle has a non-circular positioning protrusion corresponding to the limiting stops on the sleeve and formed between the inside surface of the head and the inside rod; and
a limiting spacer is mounted securely on the pintle and has
a keyhole engaging the positioning protrusion of the pintle;
an edge; and
a limiting protrusion formed transversely on the edge of the limiting spacer and selectively abutting the limiting stops on the sleeve.
